(19) United States
(12) Patent Application Publication
(10) Pub. No.: US 2026/0301198 A1
(43) Pub. Date: Oct. 1, 2026

(54) Method for Myocardial Strain Analysis of Cardiac Magnetic Resonance Images Using a Diffusion Motion Model

(71) Applicant: University of Virginia Patent Foundation, Charlottesville, VA (US)

(72) Inventors: Miaomiao Zhang, Charlottesville, VA (US); Frederick H. Epstein, Charlottesville, VA (US); Jiarui Xing, Charlottesville, VA (US); Sona Ghadimi, Charlottesville, VA (US)

(21) Appl. No.: 19/632,165

(22) Filed: Mar. 27, 2026

Related U.S. Application Data
(60) Provisional application No. 63/779,058, filed on Mar. 27, 2025.

(51) Int. Cl. G06T 7/246; G06T 7/00

(52) U.S. Cl. CPC G06T 7/248; G06T 7/0014; G06T 2207/10016; G06T 2207/10088; G06T 2207/20081; G06T 2207/20084; G06T 2207/30048

(57) ABSTRACT

Predicting motion data from cardiac magnetic resonance (CMR) cine data uses a registration mapping framework machine language model (MLM) to learn latent velocity features from intermediate deformations fields calculated with initial velocities of motion data taken from frames of image data. A probabilistic latent diffusion MLM constructs updated motion data from the latent velocity features by calculating a noisy motion feature set corresponding to the frames of image data by iteratively adding random Gaussian noise to the latent velocity features in a forward diffusion process and applying a reverse diffusion process to the noisy motion feature set to create a refined set of latent velocity features. The refined set of latent velocity features are applied to a motion decoder to create updated motion data.

### CROSS-REFERENCE TO RELATED APPLICATION

This application claims priority to and incorporates by reference U.S. Provisional Patent Application Ser. No. 63/779,058 filed on Mar. 27, 2025, and entitled Method and System for Generative Diffusion Motion Model for Improved Myocardial Strain Analysis of Cine Magnetic Resonance Images.

### STATEMENT REGARDING FEDERALLY FUNDED RESEARCH

This invention was made with government support under NSF Career Grant 2239977 awarded by the National Science Foundation and Grant No.; EB 032597 awarded by the National Institutes of Health. The government has certain rights in the invention.

### FIELD

This disclosure presents a computer implemented method of tracking and recording motion data from videos of cardiac magnetic resonance (CMR) cine data with greater accuracy by incorporating noise diffusion models into the process of identifying motion features in original video data.

### BACKGROUND

Machine Learning (ML) and Artificial Intelligence (AI) systems are in widespread use in customer service, marketing, and other industries including medical imaging. Machine learning is considered a subset of a more general artificial intelligence operation, and generally, AI endeavors may utilize numerous instances of machine learning to make decisions, predict outputs, and perform human-like intelligent operations. Machine learning protocols typically involve programming a model that instantiates an appropriate algorithm, training the model on a particular data set or domain with known historical results, and using the protocol within an overall design for a specific use case. Machine learning (ML) includes, but is not limited to, a number of models, including neural networks, deep learning algorithms, support vector machines, data clustering, regression models, Monte Carlo simulations, and many more such as Linear regression, Logistic regression, Support vector machine, K-means clustering, Neural network, classification model: binary classifier; multi-class classifier, Clustering model, Anomaly detection, Other Supervised learning model, Other unsupervised learning model, Combination of one or more ML model types. Most of these take vectors of data as inputs.

Some machine learning models are designed for a specific data set or domain and are highly expert at handling the nuances within that narrow domain. For example, a model for recognizing spoken words will be highly tuned to the acoustic and linguistic aspects of speech and conversation. While effective for the intended use case, these systems are difficult to apply a new or different use case. For example, re-using a model designed to provide a score for a credit score would be difficult (requiring involving time, effort, and specialized expertise) to apply to a retention model where the credit score algorithm could be an effective input.

### SUMMARY

Other aspects and features according to the example embodiments of the disclosed technology will become apparent to those of ordinary skill in the art, upon reviewing the following detailed description in conjunction with the accompanying figures.

Predicting motion data from cardiac magnetic resonance (CMR) cine data uses a registration mapping framework machine language model (MLM) to learn latent velocity features from intermediate deformations fields calculated with initial velocities of motion data taken from frames of image data. A probabilistic latent diffusion MLM constructs updated motion data from the latent velocity features by calculating a noisy motion feature set corresponding to the frames of image data by iteratively adding random Gaussian noise to the latent velocity features in a forward diffusion process and applying a reverse diffusion process to the noisy motion feature set to create a refined set of latent velocity features. The refined set of latent velocity features are applied to a motion decoder to create updated motion data.

### BRIEF DESCRIPTION OF THE DRAWINGS

Reference will now be made to the accompanying drawings, which are not necessarily drawn to scale.

FIG. 1A is an overview of the proposed network framework of this disclosure and shows Part (A) as a Registration-based network to learn latent motion features represented by initial velocity fields. Part (B) is a diffusion model in latent motion spaces.

FIG. 1B is a schematic of a computer environment used in accordance with the disclosure herein.

FIG. 1C is a schematic of a computer environment used in accordance with the disclosure herein.

FIG. 2A shows exemplary comparison of end-systolic displacement and circumferential strain maps (Ecc) for a healthy patient subject. FIG. 2A is derived from DENSE input across all methods. Left to right: DENSE ground truth and predictions from our model vs. baselines. Top to bottom: enlarged view of selected displacement region; full displacements; circumferential strain maps (contraction in blue vs. stretch in red).

FIG. 2B shows exemplary comparison of end-systolic displacement and circumferential strain maps (Ecc) for a heart failure patient with left bundle branch block. FIG. 2B is derived from DENSE input across all methods. Left to right: DENSE ground truth and predictions from our model vs. baselines. Top to bottom: enlarged view of selected displacement region; full displacements; circumferential strain maps (contraction in blue vs. stretch in red).

FIG. 3A shows exemplary comparison of end-systolic displacement and circumferential strain maps (Ecc) derived from standard cine MRI videos. FIG. 3A is for a healthy volunteer.

FIG. 3B shows exemplary comparison of end-systolic displacement and circumferential strain maps (Ecc) derived from standard cine MRI videos. FIG. 3B is for heart failure patient with left bundle branch block.

FIG. 4 is a comparison of displacement field EPE error on DENSE and from Left to Right the figure shows predicted segmental circumferential strain error on DENSE; and predicted segmental circumferential strain error on standard cine CMRs from our model vs. all baselines.

FIG. 5 shows a comparison of time-sequential myocardial strain generated by DENSE vs. our model throughout the cardiac cycle.

FIG. 6 consolidates formulas and equations used in this disclosure.

FIG. 7 shows steps of implementing a diffusion network according to this disclosure.

### DETAILED DESCRIPTION

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

As discussed herein, a “subject” (or “patient”) may be any applicable human, animal, or other organism, living or dead, or other biological or molecular structure or chemical environment, and may relate to particular components of the subject, for instance specific organs, tissues, or fluids of a subject, may be in a particular location of the subject, referred to herein as an “area of interest” or a “region of interest.”

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. All references cited and discussed in this specification are incorporated herein by reference in their entireties and to the same extent as if each reference was individually incorporated by reference.

In the following description, references are made to the accompanying drawings that form a part hereof and that show, by way of illustration, specific embodiments or examples. In referring to the drawings, like numerals represent like elements throughout the several figures.

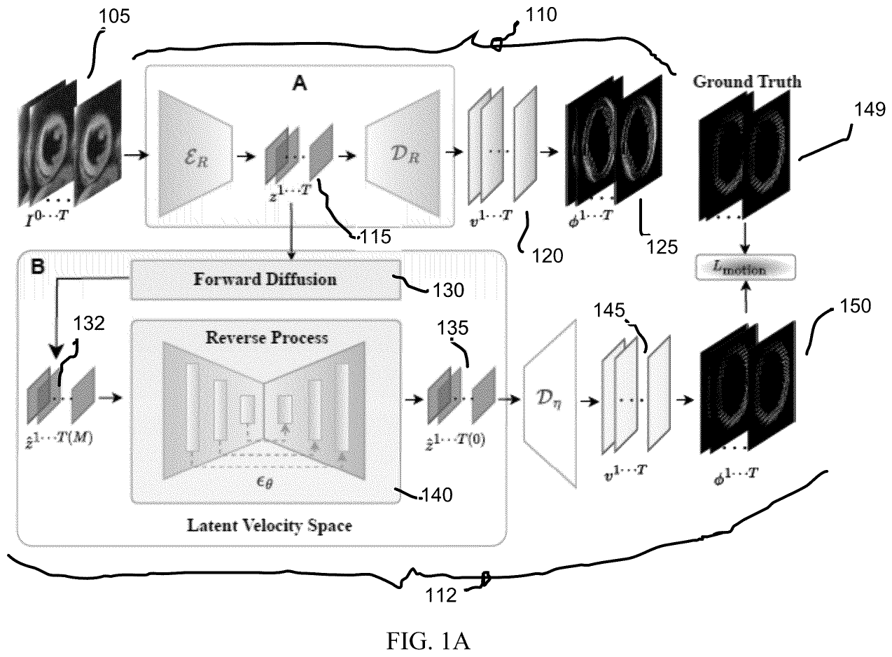

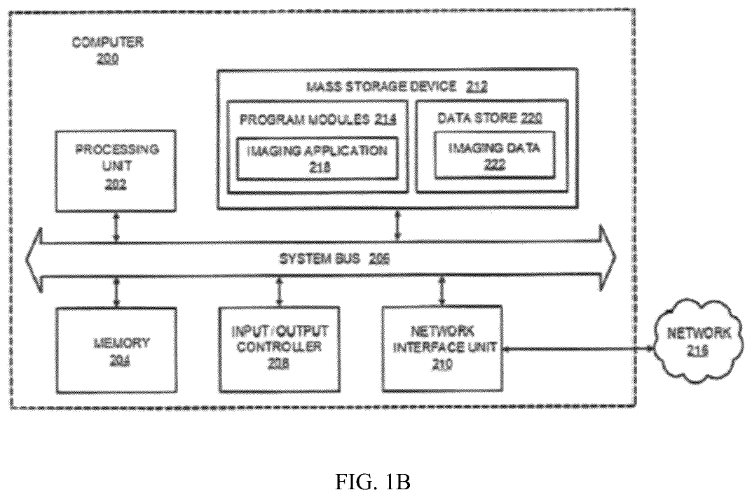

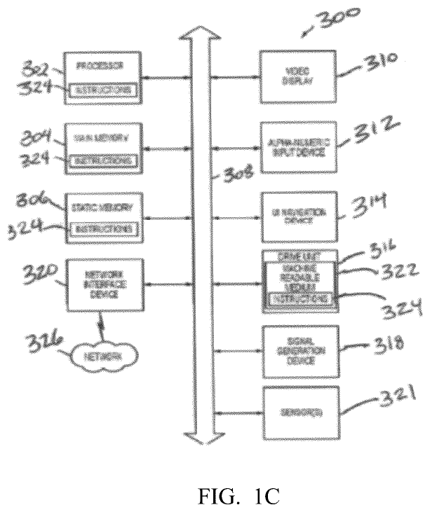

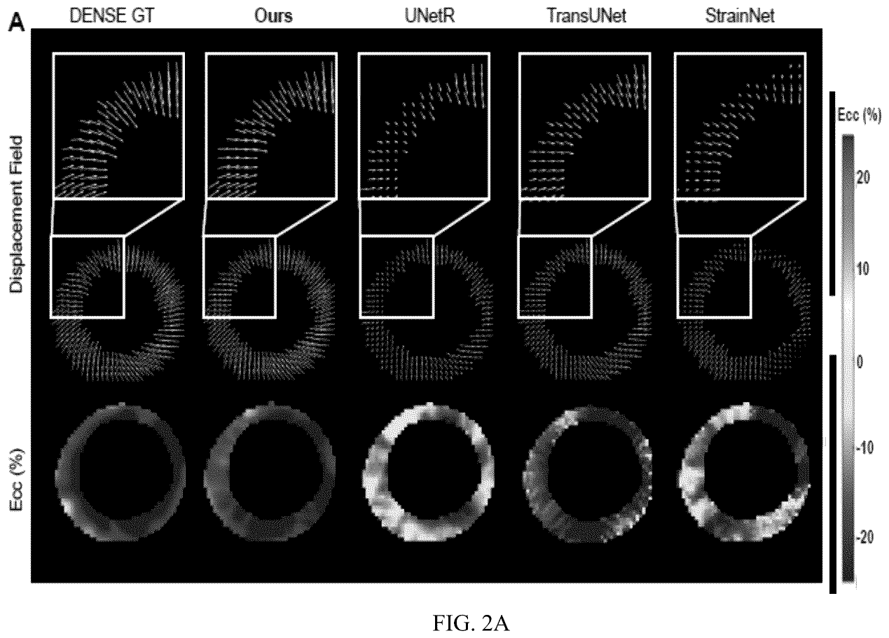

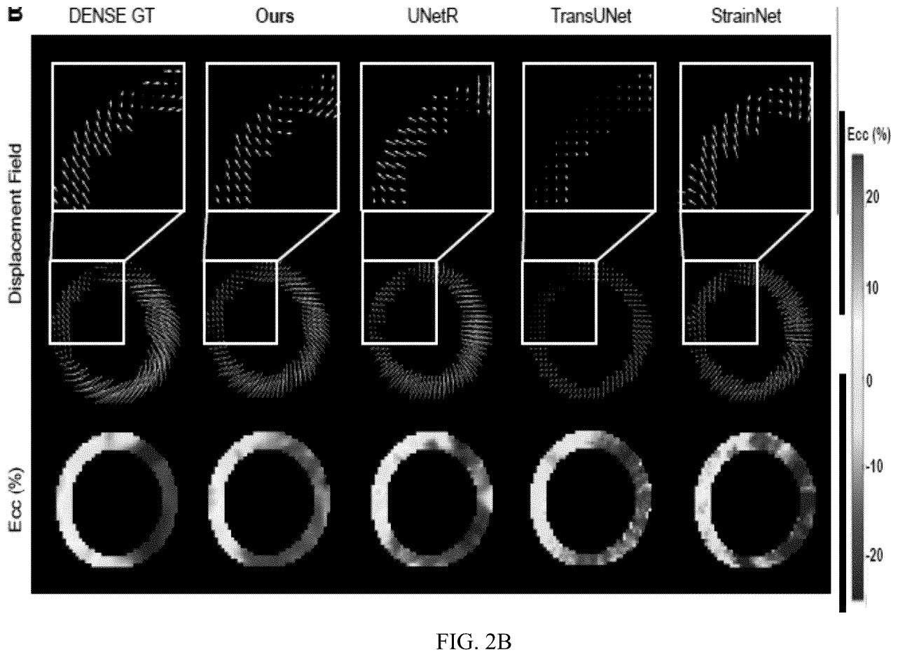

FIG. 2 is a computer architecture diagram showing a general computing system capable of implementing aspects of the present disclosure in accordance with one or more embodiments described herein. A computer 200 may be configured to perform one or more functions associated with embodiments of this disclosure. For example, the computer 200 may be configured to perform operations of the method as described below. It should be appreciated that the computer 200 may be implemented within a single computing device or a computing system formed with multiple connected computing devices. The computer 200 may be configured to perform various distributed computing tasks, which may distribute processing and/or storage resources among the multiple devices. The data acquisition and display computer 150 and/or operator console 110 of the system shown in FIG. 1 may include one or more systems and components of the computer 200.

As shown, the computer 200 includes a processing unit 202 (“CPU”), a system memory 204, and a system bus 206 that couples the memory 204 to the CPU 202. The computer 200 further includes a mass storage device 212 for storing program modules 214. The program modules 214 may be operable to perform one or more functions associated with embodiments of method as illustrated in one or more of the figures of this disclosure, for example to cause the computer 200 to perform operations of the automated DENSE analysis as described below. The program modules 214 may include an imaging application 218 for performing data acquisition functions as described herein, for example to receive image data corresponding to magnetic resonance imaging of an area of interest. The computer 200 can include a data store 220 for storing data that may include imaging-related data 222 such as acquired image data, and a modeling data store 224 for storing image modeling data, or other various types of data utilized in practicing aspects of the present disclosure.

The mass storage device 212 is connected to the CPU 202 through a mass storage controller (not shown) connected to the bus 206. The mass storage device 212 and its associated computer-storage media provide non-volatile storage for the computer 200. Although the description of computer-storage media contained herein refers to a mass storage device, such as a hard disk or CD-ROM drive, it should be appreciated by those skilled in the art that computer-storage media can be any available computer storage media that can be accessed by the computer 200.

By way of example, and not limitation, computer-storage media (also referred to herein as a “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 200. Transitory signals are not “computer-storage media”, “computer-readable storage medium” or “computer-readable storage media” as described herein.

According to various embodiments, the computer 200 may operate in a networked environment using connections to other local or remote computers through a network 216 via a network interface unit 210 connected to the bus 206. The network interface unit 210 may facilitate connection of the computing device inputs and outputs to one or more suitable networks and/or connections such as a local area network (LAN), a wide area network (WAN), the Internet, a cellular network, a radio frequency network, a Bluetooth-enabled network, a Wi-Fi enabled network, a satellite-based network, or other wired and/or wireless networks for communication with external devices and/or systems. The computer 200 may also include an input/output controller 208 for receiving and processing input from a number of input devices. Input devices may include one or more of keyboards, mice, stylus, touchscreens, microphones, audio capturing devices, or image/video capturing devices. An end user may utilize such input devices to interact with a user interface, for example a graphical user interface, for managing various functions performed by the computer 200.

The bus 206 may enable the processing unit 202 to read code and/or data to/from the mass storage device 212 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state or may include rotating media storing magnetically-encoded information. The program modules 214, which include the imaging application 218, may include instructions that, when loaded into the processing unit 202 and executed, cause the computer 200 to provide functions associated with embodiments illustrated herein. The program modules 214 may also provide various tools or techniques by which the computer 200 may participate within the overall systems or operating environments using the components, flows, and data structures discussed throughout this description.

In general, the program modules 214 may, when loaded into the processing unit 202 and executed, transform the processing unit 202 and the overall computer 200 from a general-purpose computing system into a special-purpose computing system. The processing unit 202 may be constructed from any number of transistors or other discrete circuit elements, which may individually or collectively assume any number of states. More specifically, the processing unit 202 may operate as a finite-state machine, in response to executable instructions contained within the program modules 214. These computer-executable instructions may transform the processing unit 202 by specifying how the processing unit 202 transitions between states, thereby transforming the transistors or other discrete hardware elements constituting the processing unit 202.

Encoding the program modules 214 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer-storage media are implemented as semiconductor-based memory, the program modules 214 may transform the physical state of the semiconductor memory, when the software is encoded therein. For example, the program modules 214 may transform the state of transistors, capacitors, or other discrete circuit elements constituting the semiconductor memory.

As another example, the computer-storage media may be implemented using magnetic or optical technology. In such implementations, the program modules 214 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 300) and software architectures that can be deployed in example embodiments.

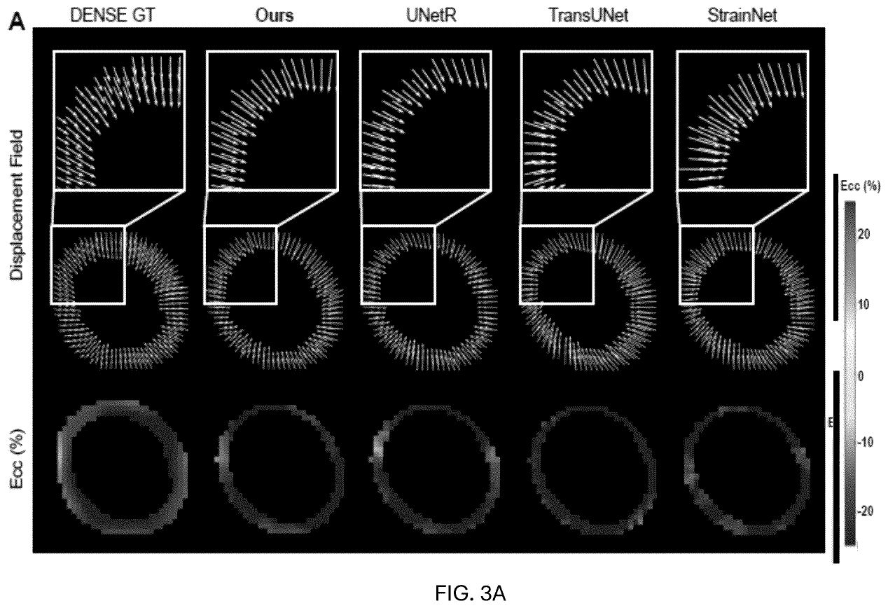

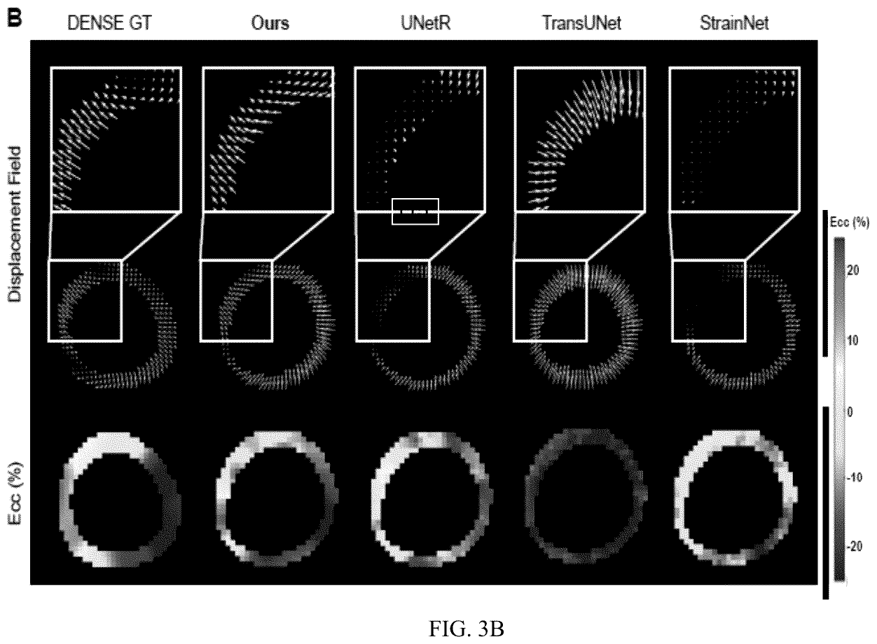

The machine 300 of FIG. 3 can operate as a standalone device or the machine 300 can be connected (e.g., networked) to other machines. In a networked deployment, the machine 300 can operate in the capacity of either a server or a client machine in server-client network environments. In an example, machine 300 can act as a peer machine in peer-to-peer (or other distributed) network environments. The machine 300 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 300. Further, while only a single machine 300 is illustrated, the term “machine” shall also be taken to include any collection of machines that individually or jointly execute a set (or multiple sets) of instructions to perform any one or more of the methodologies discussed herein.

Example machine (e.g., computer system) 300 can include a processor 302 (e.g., a central processing unit (CPU), a graphics processing unit (GPU) or both), a main memory 304 and a static memory 306, some or all of which can communicate with each other via a bus 308. The machine 300 can further include a display unit 310, an alphanumeric input device 312 (e.g., a keyboard), and a user interface (UI) navigation device 311 (e.g., a mouse). In an example, the display unit 810, input device 317 and UI navigation device 314 can be a touch screen display. The machine 300 can additionally include a storage device (e.g., drive unit) 316, a signal generation device 318 (e.g., a speaker), a network interface device 320, and one or more sensors 321, such as a global positioning system (GPS) sensor, compass, accelerometer, or other sensor. The storage device 316 can include a machine readable medium 322 on which is stored one or more sets of data structures or instructions 324 (e.g., software) embodying or utilized by any one or more of the methodologies or functions described herein. The instructions 324 can also reside, completely or at least partially, within the main memory 304, within static memory 306, or within the processor 302 during execution thereof by the machine 300. In an example, one or any combination of the processor 302, the main memory 304, the static memory 306, or the storage device 316 can constitute machine readable media. While the machine readable medium 322 is illustrated as a single medium, the term “machine readable medium” can include a single medium or multiple media (e.g., a centralized or distributed database, and/or associated caches and servers) that configured to store the one or more instructions 324. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media.

Specific examples of machine readable media can include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magnetooptical disks; and CD-ROM and DVD-ROM disks. The instructions 324 can further be transmitted or received over a communications network 326 using a transmission medium via the network interface device 320 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

Motion and deformation analysis of CMR videos provides valuable measurements to quantify myocardial strain in patients with heart disease, offering clinically significant data for disease assessment, diagnosis, and treatment planning [17,3,24,29,30]. CMR feature tracking (FT) is widely used in clinical practice to evaluate myocardial motion, deformation, and strain functions [25,15,18,19].

Such a technique employs optical flow-based algorithms [10] to track image features or patterns within the myocardium throughout the cardiac cycle. While FT is convenient and integrates well into routine clinical workflows, this technique is generally less accurate due to its limited motion tracking accuracy [1,32].

With recent advancements in deep learning, several research groups have utilized image registration-based networks to predict myocardial motion and strain from CMR images [15,18,31]. Existing methods incorporated new regularization techniques, such as enforcing temporal consistency [18], or introducing prior knowledge of cardiac biomechanics [21,35,20], to achieve improved motion prediction quality. However, these approaches still partially address the challenges of detecting motion in regions with subtle image appearance changes (i.e., the myocardium mid-wall motion) [1,6,16], leading to compromised accuracy of myocardial strain measurements. To alleviate this issue, another research line has utilized “ground-truth” data from the advanced imaging technique DENSE, which provides highly accurate and reproducible myocardial motion data to supervise the motion learning process [27,28]. In contrast to conventional CMR techniques, DENSE directly encodes tissue displacement within the imaging data, allowing for precise quantification of myocardial motion throughout the cardiac cycle. Despite promising progress in predicting myocardial motion for improved strain analysis under the guidance of DENSE [27,28], current approaches heavily rely on features extracted from segmented myocardial contours rather than the underlying cardiac motions, potentially compromising strain accuracy.

Furthermore, the network training involved only DENSE contours that may not fully generalize to standard CMR images. To address this problem, this disclosure proposed to develop a novel Latent Motion Diffusion model (LaMoD) to further improve the current deep networks to predict highly accurate DENSE motions from standard CMR videos. In particular, our method, LaMoD, first employs an encoder from a pre-trained registration network that learns latent motion features of myocardial deformations derived from both cine and DENSE image sequences. Supervised by the ground-truth motion provided by DENSE, LaMoD then leverages a probabilistic latent diffusion model to reconstruct accurate motion from these extracted features. Once our model is trained, the DENSE data is no longer required in the testing phase.

Contributions of this disclosure include but are not limited to:
(i) Develop a new framework, LaMoD, that generates time-sequential myocardial deformation fields from a learned latent space of motion features.
(ii) Our method is the first to leverage latent diffusion models in the motion space to produce highly accurate myocardial strain from standard CMR videos.
(iii) Opens promising research avenues for transferring knowledge from advanced strain imaging to routinely acquired CMR data; hence maximizing benefits for patients with cardiac diseases.

This section includes the concept of image registration, which is a fundamental technique for estimating motion deformation between images. This disclosure will apply this concept to motion tracking in CMR video sequences.

Motion and deformation analysis of cardiac magnetic resonance (CMR) imaging videos is crucial for assessing myocardial strain of patients with abnormal heart functions. Recent advances in deep learning-based image registration algorithms have shown promising results in predicting motion fields from routinely acquired CMR sequences.

However, their accuracy often diminishes in regions with subtle appearance changes, with errors propagating over time. Advanced imaging techniques, such as displacement encoding with stimulated echoes (DENSE) CMR, offer highly accurate and reproducible motion data but require additional image acquisition, which poses challenges in busy clinical flows. In this paper, the disclosure introduces a novel Latent Motion Diffusion model (LaMoD) to predict highly accurate DENSE motions from standard CMR videos. More specifically, our method first employs an encoder from a pre-trained registration network that learns latent motion features (also considered as deformation-based shape features) from image sequences.

Supervised by the ground-truth motion provided by DENSE, LaMoD then leverages a probabilistic latent diffusion model to reconstruct accurate motion from these extracted features. Experimental results demonstrate that our proposed method, LaMoD, significantly improves the accuracy of motion analysis in standard CMR images; hence improving myocardial strain analysis in clinical settings for cardiac patients. Our code is publicly available at https://github.com/jr-xing/LaMoD.

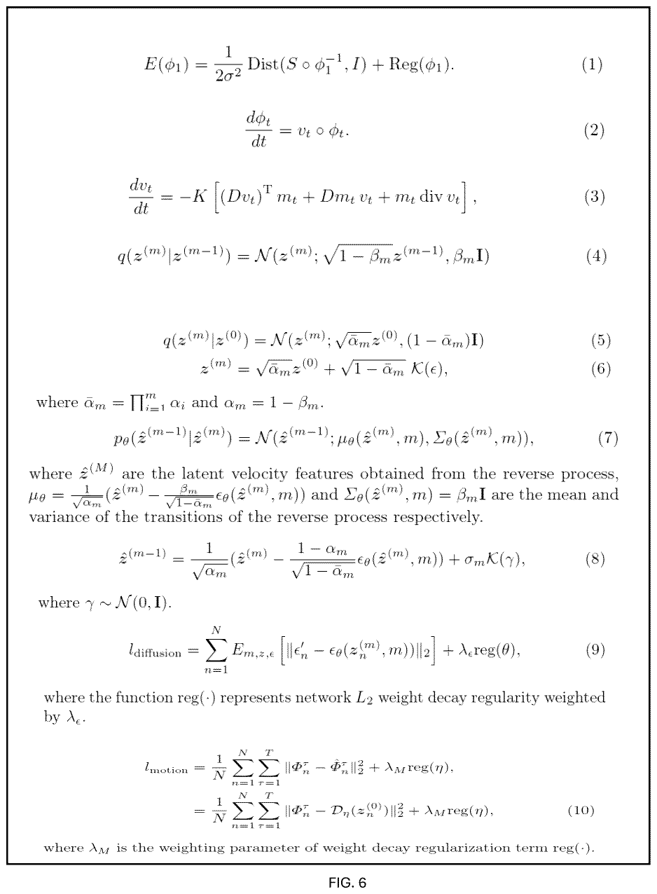

Given a source image S and a target image I, the problem of diffeomorphic image registration is typically formulated as an energy minimization over a time dependent deformation fields, {φt:t∈[0, 1]}, i.e., Equation 1 of FIG. 6. In Equation 1, the symbol ∘ denotes an interpolation operator, which deforms a source image S to match the target I. The Dist(·, ·) is a distance function that measures the dissimilarity between images weighted by a positive parameter σ, and Reg(⋅) is a regularization term to enforce the smoothness of transformation fields. This paper uses a commonly used sum-of-squared intensity differences (L2-norm) [4] as the distance function.

The implementations adopt the large diffeomorphic deformation metric mapping (LDDMM) framework [4,34] to generate diffeomorphic deformations, parameterized by time-dependent velocity fields, vt:t∈[0, 1], i.e., Equation 2 of FIG. 6.

A geodesic shooting algorithm [13,26] has shown that the geodesic path of deformation, φt, with a given initial condition, v0, can be uniquely determined through integrating the Euler-Poincare′ differential equation (EPDiff) [2,14] as Equation 3 of FIG. 6.

Our model consists of two main components: (i) a pre-trained registration network based on the LDDMM framework [4] to extract latent motion features from CMR sequences, and (ii) a motion prediction model leveraging latent diffusion models to reconstruct realistic and highly accurate myocardial motion, supervised by DENSE data. An overview of our proposed framework, LaMoD, is illustrated in FIG. 1.

Given a image sequence, {Iτ}Tτ=0, that includes T+1 time frames covering an entire motion cycle of myocardium. This disclosure pre-trains a LDDMM-based registration network [8] to learn the deformation fields between the initial frame I0 and each subsequent frame {Iτ} . This results in a number of T pairs of images, i.e., {(I0, I1), (I0, I2) ⋅⋅⋅, (I0, IT)}. To utilize the intrinsic spatial connections and motion consistency across the sequence of time frames, and stack the T pairwise images into a 3D volume and predict the deformation fields simultaneously in the implementation. This disclosure employs an UNet architecture [23] as our network backbone, featuring an encoder ER that maps the input image pairs {(I0, Iτ) } to the corresponding latent velocity features {zτ} , and a decoder DR that project {zτ} back to the input image space, i.e., initial velocity fields {vτ0} . The corresponding final transformation fields, {φτ1}, are computed through Eq. (2) and Eq. (3). For a simplified notation, the paper will drop the time index in following sections, i.e., Φ(1 to τ)Δ=φτ and v(0 to τ)Δ=vτ.

This disclosure introduces a new latent motion diffusion module that captures the complex distribution of latent motion features, resulting in higher quality motion reconstruction under the supervision of DENSE ground-truth. More specifically, the registration-based latent velocity features are first refined through a diffusion process and then fed into a motion reconstruction network to predict the final, highly accurate myocardial motion. This approach ensures a more precise and realistic depiction of myocardial dynamics, demonstrating significant improvements over existing methods.

Inspired by the Denoising Diffusion Probabilistic Models (DDPM)[9,22], this disclosure formulates the model as a latent Markov chain with M steps. The framework has a forward and reverse diffusion process. The forward process iteratively adds random Gaussian noise to the input latent features over m∈[1, 2, . . . , M] steps. Similar to [11], this technique employs smoothed Gaussian noise ϵ′ in the diffusion process to facilitate faster optimization convergence compared to normal Gaussian noise ϵ, i.e. ϵ′=K(ϵ), where ϵ~N(0, I) and K(⋅) is a Gaussian smoothing kernel.

Defining z(m) [symbol] {z1(m), z2(m), . . . , zT(m)} as the learned latent motion features (represented by initial velocities) for all frames at step m, our forward diffusion process is defined as Equation 4 of FIG. 6. where βm is a time-dependent variance schedule used to parameterize the probabilistic transitions. The forward process starts from the registration-based latent feature, i.e. z(0)={zτ}={z1, z2, . . . , zT} . Alternatively, the forward diffusion process can be formulated as a single step process as shown in Equation 5 and Equation 6 in FIG. 6.

The reverse diffusion process aims to restore the latent feature with a deep neural network. It takes place over m steps as Equation 7 of FIG. 6. The reverse process is implemented by training a noise-prediction network ϵθ that takes the noisy motion feature \hat{z}(m) and the step m as input. For each step m, the sampling in the reverse process is defined as Equation 8 of FIG. 6.

Noting the shared diffusion step as m, and latent features as well as the additive noise of the n-th input sequence as z(m) n and ϵ′n respectively, the corresponding loss function over the whole training dataset with N sequences is defined as Equation 9 of FIG. 6 where the function reg(⋅) represents network L2 weight decay regularity weighted by λϵ.

The refined latent features z(0) are fed into to the motion decoder, Dη, to reconstruct the accurate myocardial motion of original data resolution, i.e., Φhat sub n={Φhat1 sub n, Φhat2 sub n, . . . ΦhatT sub n}=D η (z(n to (0)) where η is the motion decoder and n∈{1, ⋅⋅⋅, N} is the data index. With the supervision of DENSE ground truth, Φn, our motion reconstruction loss is defined as Equation 10 of FIG. 6.

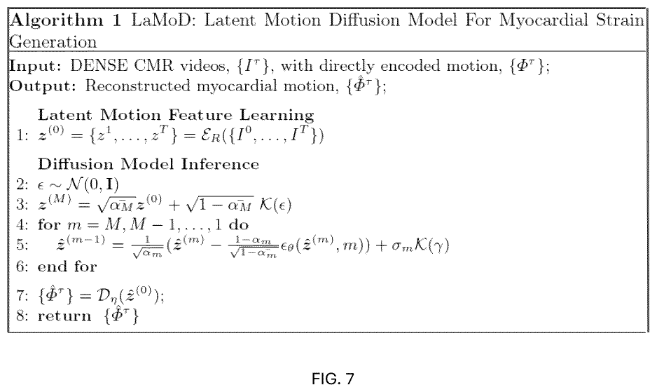

These disclosures jointly train the loss functions of diffusion model (Eq. (9)) and the motion reconstruction (Eq. (10)) till its convergence. This disclosure will define the total loss as ltotal=ldiffusion+αlmotion, where α is the loss weighting term. This disclosure will summarize the diffusion model in Algorithm 1 of FIG. 7.

This disclosure will first demonstrate the effectiveness of LaMoD on DENSE CMR videos and then test its performance on standard cine CMRs, highlighting its clinical potential. Both quantitative and visualization results are presented. Note that our network is trained solely on the DENSE dataset and then tested on both DENSE and CINE datasets.

The training of all our experiments is implemented on an server with AMD EPYC 7502 CPU of 126 GB memory and Nvidia GTX 3090Ti GPUs. This disclosure will train our networks using Adam optimizer [12] with maximal 2000 epochs with the early stop strategy. The batch size is set to 32 and weight decay weights are set to λϵ=λM=1E−4. The hyper-parameters are optimized with grid search strategy. The optimal learning rate is 1E−4 and the optimal loss weight is α=1E−2.

### Dataset

DENSE CMR videos with directly encoded motion data. This disclosure will utilize 741 DENSE CMR videos of the left ventricular (LV) myocardium collected from 284 subjects, including 124 healthy volunteers and 160 patients with various types of heart disease. Data are collected from eight centers (University of Virginia, Charlottesville; University Hospital, Saint-Etienne, France; University of Kentucky, Lexington; University of Glasgow, Scotland; St Francis Hospital, New York; the Royal Brompton Hospital, London, England; Emory University, Atlanta, Georgia; and Stanford University, Palo Alto, California). Each DENSE scan was performed in 4 short-axis planes at the basal, two midventricular, and apical levels (with temporal resolution of 17 ms, pixel size of 2.652 mm2, and slice thickness=8 mm). Other parameters include displacement encoding frequency ke=0.1 cycles/mm, flip angle 15°, and echo time=1.08 ms. Standard cine CMR videos. This disclosure tested our proposed model on 105 short axis cine CMRs slices of 40 subjects from the DENSE dataset mentioned above, including 14 patients and 26 volunteers. All scans were acquired during repeated breath hold covering the left ventricle (LV) (field of view, 320×320 to 380×380 mm2; temporal resolution, 30-55 msec, depending on heart rate). Each selected cine slice corresponds to a DENSE scan of the same patient at the same spatial location (within +/−2 mm), allowing the DENSE displacement field to serve as the ground-truth motion for the cine slices.

Data Pre-processing. All cine and DENSE CMR sequences were temporally and spatially aligned for efficient network training. In particular, the standard cine sequences were temporally resampled to 40 frames to match the DENSE temporal resolution. All images were resampled to a 1 mm2 resolution and cropped to 128×128. We ran all experiments on binary LV myocardium segmentation from both cine and DENSE sequences to avoid appearance gaps between the magnitude images, using masks manually labeled by clinical experts.

This disclosure used all standard CMR and DENSE videos to train our registration network that can effectively learn latent motion features. However, This disclosure only uses DENSE motion to train the diffusion model to reconstruct myocardial deformations. In particular, the DENSE data set was divided into 538 samples for training, 101 for validation and 102 for testing. This disclosure employed a site-balanced splitting strategy, maintaining consistent proportions from each site across all sets to ensure representative sampling and mitigate site-specific biases. Paired DENSE data with cine CMR videos were used for regional segmental strain comparison in our experimental evaluation.

Evaluate motion and strain error on DENSE data. This disclosure first evaluate the quality of predicted motions for DENSE sequences, using pixel-wise motion field error (i.e., end-point error (EPE)) defined as the Euclidean distance between the predicted and ground truth motion vectors. This disclosure compares the performance of our proposed model with three state-of-the-art deep learning-based motion/strain prediction models—StrainNet [27], UNetR [7], 3D TransUNet [5]. All methods are trained on the same dataset, and their best performances are reported.

This disclosure then generates strain maps from the predicted motion fields for the DENSE input and compare it with all baseline algorithms. This disclosure performed a quantitative analysis of strain errors on regional segmental strains. Consistent with previous studies [27,28], This disclosure divided the myocardium in each DENSE slice into six segments, starting from the right ventricle insertion point and proceeding counterclockwise.

This disclosure then calculated the average absolute error for strain evaluation in each segment.

Evaluate strain error on standard cine CMR videos. For cine sequences, our evaluation focuses exclusively on segmental strain error due to the significant differences between the paired DENSE contours and the collected cine CMR myocardium contours. This is mainly due to the spatial misalignment between the myocardium regions from input cine images and the DENSE-derived ground truth, which are collected from separate scans, making pixel-wise error computation impractical. This disclosure applies the same segmental strain approach as used for the DENSE data, dividing the myocardium into six segments and calculating the average absolute strain error for each. Furthermore, This disclosure compared strain values with those obtained using widely used commercial software (SuiteHeart version 5.0.4; NeoSoft) based on Feature Tracking (FT) in clinical settings.

FIG. 2 (test on DENSE data) presents the visualizations of the predicted endsystolic displacement fields and the circumferential (Ecc) strain maps for all models compared to the ground truth from DENSE ground truth. To provide a comprehensive evaluation, This disclosure include examples from both healthy volunteers (top panel: ground A) and patients with heart failure (bottom panel: ground B), specifically those with left bundle branch block (LBBB). The predictions generated by our method consistently show a closer resemblance to the ground truth across all cases. These results collectively demonstrate that our method provides more accurate and robust performance compared to the baseline models.

Similarly, the FIG. 3 (test on standard cine CMRs) visualizes the predicted motion fields and the circumferential (Ecc) strain maps for all models compared to paired DENSE dataset. Note that the DENSE myocardium contours are slightly different from cine CMRs due to a different scanning time.

### LaMoD

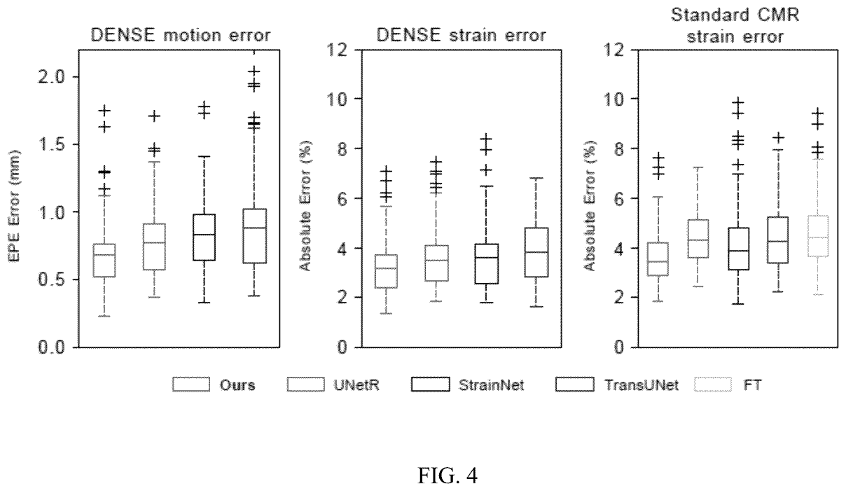

FIG. 4 displays a quantitative comparison of displacement field EPE error and segmental circumferential strain error between our model and all baselines. The left two panels demonstrate the testing results on DENSE dataset, indi displacement and circumferential strain error. The right panel shows the testing results on the cine CMRs dataset. It shows that our method consistently achieves superior performance of myocardial strain quality over all baselines, indicating that our method significantly outperforms the baselines in terms of both displacement and circumferential strain error. The right panel shows the testing results on the cine CMRs dataset. It shows that our method consistently achieves superior performance of myocardial strain quality over all baselines.

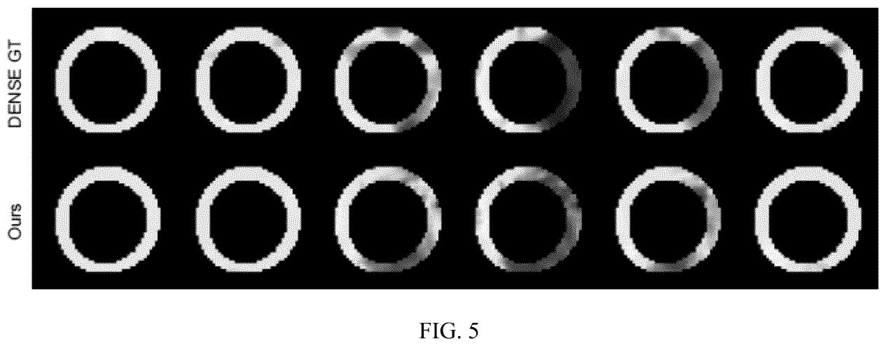

FIG. 5 illustrates a comparison between circumferential strain computed from DENSE and our predictions across evenly sampled time frames throughout the cardiac cycle. The visual similarity between the top and bottom rows demonstrates that our method effectively captures the strain patterns at various phases of cardiac motion.

Embodiments of this disclosure include a computer implemented method of predicting motion data from cardiac magnetic resonance (CMR) cine data from videos having frames 105 of image data, the method includes using a computer having a processor and computer implemented memory storing software to implement machine learning models (MLM) stored in the memory. The method uses a registration mapping framework MLM 110 to learn latent velocity features 115 from intermediate deformations fields calculated with initial velocities 120 of motion data taken from the frames of image data. The method continues by using a probabilistic latent diffusion MLM 130, 132 to construct updated motion data 150 from the latent velocity features by implementing steps of storing, in the memory of the computer, a noisy motion feature set 132 corresponding to the frames of image data by iteratively adding random Gaussian noise to the latent velocity features in a forward diffusion process. In continued processing, the method applies a reverse diffusion process 140 to the noisy motion feature set to create a refined set 135 of latent velocity features and applies the refined set of latent velocity features to a motion decoder (D) to create the updated motion data 150.

In non-limiting embodiments, the computer implemented method further comprises using the mapping framework MLM to determine respective intermediate deformation fields between an initial frame and each subsequent frame of the cine data.

In non-limiting embodiments, the computer implemented method further comprises determining the respective intermediate deformation fields by storing a 3D volume of stacked image pairs with each pair comprising an initial frame of the image data and a respectively subsequent frame of the image data, and applying the 3D volume to a U-Net MLM architecture.

In non-limiting embodiments, the computer implemented method further comprises using the U-Net MLM architecture to calculate the respective intermediate deformation fields and determine latent velocity features of the frames of image data.

In non-limiting embodiments, the computer implemented method further comprises the latent velocity features comprising a time dependent velocity vector field calculated from the respective intermediate deformation fields based on initial velocity fields.

In non-limiting embodiments, the computer implemented method further comprises using the mapping framework MLM and the intermediate deformation fields to learn other latent motion features besides latent velocity features in the cine data based on initial velocity fields.

In non-limiting embodiments, the computer implemented method further comprises calculating and storing corrected deformation fields by implementing the probabilistic latent diffusion MLM in supervised learning using ground truth motion provided by previously confirmed displacement encoding with stimulated echoes (DENSE) data from historical training images.

In non-limiting embodiments, the computer implemented method further comprises the reverse diffusion process utilizing a deep neural network to calculate the refined set of latent velocity features for the frames of image data.

In non-limiting embodiments, the computer implemented method further comprises the motion decoder projecting the refined set of latent velocity features back into initial velocity fields based on the latent velocity features identified by the registration mapping framework MLM.

In non-limiting embodiments, the computer implemented method further comprises predicting motion data from cardiac magnetic resonance (CMR) cine data from videos having frames of image data, wherein the software provides a computer implemented method comprising using a computer having a processor and computer implemented memory storing the software to implement machine learning models (MLM) stored in the memory; using a registration mapping framework MLM to learn latent velocity features from intermediate deformations fields calculated with initial velocities of motion data taken from the frames of image data; and using a probabilistic latent diffusion MLM to construct updated motion data from the latent velocity features by implementing steps comprising storing, in the memory of the computer, a noisy motion feature set corresponding to the frames of image data by iteratively adding random Gaussian noise to the latent velocity features in a forward diffusion process; and applying a reverse diffusion process to the noisy motion feature set to create a refined set of latent velocity features; applying the refined set of latent velocity features to a motion decoder to create the updated motion data.

This disclosure introduced LaMoD, a novel Latent Motion Diffusion model that predicts highly accurate motions/strain from standard CMR videos. Our approach effectively addresses the challenges of detecting subtle myocardial movements, particularly in intramyocardial regions, by leveraging a pre-trained registration network and a probabilistic latent diffusion model in the latent motion space guided by DENSE CMRs. Experimental results demonstrate that LaMoD outperforms existing methods in motion prediction and strain generation accuracy.

Our work has great potential to improve cardiac disease assessment based on strain, as well as treatment planning without requiring additional DENSE scans; hence ultimately improving patient care. Future work will focus on further validating the model's generalizability across diverse patient populations and clinical environments.

This paper introduces LaMoD, a novel Latent Motion Diffusion model that predicts highly accurate motions/strain from standard CMR videos. Our approach effectively addresses the challenges of detecting subtle myocardial movements, particularly in intramyocardial regions, by leveraging a pre-trained registration network and a probabilistic latent diffusion model in the latent motion space guided by DENSE CMRs. Experimental results demonstrate that LaMoD outperforms existing methods in motion prediction and strain generation accuracy. Our work has great potential to improve cardiac disease assessment based on strain, as treatment planning without requiring additional DENSE scans; hence ultimately improving patient care. Future work will focus on further validating the model's generalizability across diverse patient populations and clinical environments.

### REFERENCES

1. Amzulescu, M.S., De Craene, M., Langet, H., Pasquet, A., Vancraeynest, D., Pouleur, A.C., Vanoverschelde, J.L., Gerber, B.: Myocardial strain imaging: review of general principles, validation, and sources of discrepancies. European Heart Journal-Cardiovascular Imaging 20(6), 605-619 (2019).
2. Arnold, V.: Sur la géométrie différentielle des groupes de lie de dimension infinie et ses applications àl'hydrodynamique des fluides parfaits. In: Annales de l'institut Fourier. vol. 16, pp. 319-361 (1966).
3. Balter, J.M., Kessler, M.L.: Imaging and alignment for image-guided radiation therapy. Journal of clinical oncology 25(8), 931-937 (2007).
4. Beg, M.F., Miller, M.I., Trouvé, A., Younes, L.: Computing large deformation metric mappings via geodesic flows of diffeomorphisms. International journal of computer vision 61(2), 139-157 (2005).
5. Chen, J., Mei, J., Li, X., Lu, Y., Yu, Q., Wei, Q., Luo, X., Xie, Y., Adeli, E., Wang, Y., et al.: 3d transunet: Advancing medical image segmentation through vision transformers. arXiv preprint arXiv:2310.07781 (2023).
6. Claus, P., Omar, A.M.S., Pedrizzetti, G., Sengupta, P.P., Nagel, E.: Tissue tracking technology for assessing cardiac mechanics: principles, normal values, and clinical applications. JACC: Cardiovascular Imaging 8(12), 1444-1460 (2015).
7. Hatamizadeh, A., Tang, Y., Nath, V., Yang, D., Myronenko, A., Landman, B., Roth, H.R., Xu, D.: Unetr: Transformers for 3d medical image segmentation. In: Proceedings of the IEEE/CVF winter conference on applications of computer vision. pp. 574-584 (2022).
8. Hinkle, J.: jacobhinkle/lagomorph (5 2021), https://github.com/jacobhinkle/lagomorph LaMoD: Latent Motion Diffusion Model For Myocardial Strain Generation 13.
9. Ho, J., Jain, A., Abbeel, P.: Denoising diffusion probabilistic models. Advances in Neural Information Processing Systems 33, 6840-6851 (2020).
10. Horn, B.K., Schunck, B.G.: Determining optical flow. Artificial intelligence 17(1-3), 185-203 (1981).
11. Jayakumar, N., Hossain, T., Zhang, M.: Sadir: Shape-aware diffusion models for 3d image reconstruction. arXiv preprint arXiv: 2309.03335 (2023).
12. Kingma, D.P., Ba, J.: Adam: A method for stochastic optimization. arXiv preprint arXiv:1412.6980 (2014).
13. Miller, M.I.: Computational anatomy: shape, growth, and atrophy comparison via diffeomorphisms. NeuroImage 23, S19-S33 (2004).
14. Miller, M.I., Trouvé, A., Younes, L.: Geodesic shooting for computational anatomy. Journal of Mathematical Imaging and Vision 24(2), 209-228 (2006).
15. Morales, M.A., Van den Boomen, M., Nguyen, C., Kalpathy-Cramer, J., Rosen, B.R., Stultz, C.M., Izquierdo-Garcia, D., Catana, C.: Deepstrain: a deep learning workflow for the automated characterization of cardiac mechanics. Frontiers in Cardiovascular Medicine 8, 730316 (2021)
16. Pedrizzetti, G., Claus, P., Kilner, P.J., Nagel, E.: Principles of cardiovascular magnetic resonance feature tracking and echocardiographic speckle tracking for informed clinical use. Journal of cardiovascular magnetic resonance 18(1), 51 (2016).
17. Popović, Z.B., Kwon, D.H., Mishra, M., Buakhamsri, A., Greenberg, N.L., Thamilarasan, M., Flamm, S.D., Thomas, J.D., Lever, H.M., Desai, M.Y.: Association between regional ventricular function and myocardial fibrosis in hypertrophic cardiomyopathy assessed by speckle tracking echocardiography and delayed hyperenhancement magnetic resonance imaging. Journal of the American Society of Echocardiography 21(12), 1299-1305 (2008).
18. Qiao, M., Wang, Y., Guo, Y., Huang, L., Xia, L., Tao, Q.: Temporally coherent cardiac motion tracking from cine mri: Traditional registration method and modern cnn method. Medical Physics 47(9), 4189-4198 (2020).
19. Qin, C., Bai, W., Schlemper, J., Petersen, S.E., Piechnik, S.K., Neubauer, S., Rueckert, D.: Joint motion estimation and segmentation from undersampled cardiac mr image. In: Machine Learning for Medical Image Reconstruction: First International Workshop, MLMIR 2018, Held in Conjunction with MICCAI 2018, Granada, Spain, Sep. 16, 2018, Proceedings 1. pp. 55-63. Springer (2018).
20. Qin, C., Wang, S., Chen, C., Bai, W., Rueckert, D.: Generative myocardial motion tracking via latent space exploration with biomechanics-informed prior. Medical Image Analysis 83, 102682 (2023).
21. Qin, C., Wang, S., Chen, C., Qiu, H., Bai, W., Rueckert, D.: Biomechanics-informed neural networks for myocardial motion tracking in mri. In: Medical Image Computing and Computer Assisted Intervention-MICCAI 2020: 23rd International Conference, Lima, Peru, Oct. 4-8, 2020, Proceedings, Part III 23. pp. 296-306. Springer (2020).
22. Rombach, R., Blattmann, A., Lorenz, D., Esser, P., Ommer, B.: High-resolution image synthesis with latent diffusion models (2021).
23. Ronneberger, O., Fischer, P., Brox, T.: U-net: Convolutional networks for biomedical image segmentation (2015).
24. Seo, D., Ho, J., Traverse, J.H., Forder, J., Vemuri, B.: Computing diffeomorphic paths with applications to cardiac motion analysis. In: 4th MICCAI Workshop on Mathematical Foundations of Computational Anatomy. pp. 83-94. Citeseer (2013).
25. Tee, M., Noble, J.A., Bluemke, D.A.: Imaging techniques for cardiac strain and deformation: comparison of echocardiography, cardiac magnetic resonance and cardiac computed tomography. Expert review of cardiovascular therapy 11(2), 221-231 (2013).
26. Vialard, F.X., Risser, L., Rueckert, D., Cotter, C.J.: Diffeomorphic 3d image registration via geodesic shooting using an efficient adjoint calculation. International Journal of Computer Vision 97, 229-241 (2012).
27. Wang, Y., Sun, C., Ghadimi, S., Auger, D.C., Croisille, P., Viallon, M., Mangion, K., Berry, C., Haggerty, C.M., Jing, L., et al.: Strainnet: Improved myocardial strain analysis of cine mri by deep learning from dense. Radiology: Cardiothoracic Imaging 5(3), e220196 (2023).
28. Wang, Y., Zhang, M., Bilchick, K., Epstein, F.: Transstrainnet: Improved strain analysis of cine mri with long-range spatiotemporal relationship learning. Journal of Cardiovascular Magnetic Resonance 26 (2024).
29. Xing, J., Ghadimi, S., Abdi, M., Bilchick, K.C., Epstein, F.H., Zhang, M.: Deep networks to automatically detect late-activating regions of the heart. In: 2021 IEEE 18th International Symposium on Biomedical Imaging (ISBI). pp. 1902-1906. IEEE (2021).
30. Xing, J., Wang, S., Bilchick, K.C., Epstein, F.H., Patel, A.R., Zhang, M.: Multitask learning for improved late mechanical activation detection of heart from cine dense mri. In: 2023 IEEE 20th International Symposium on Biomedical Imaging (ISBI). pp. 1-5. IEEE (2023).
31. Xing, J., Wu, N., Bilchick, K., Epstein, F., Zhang, M.: Multimodal learning to improve cardiac late mechanical activation detection from cine mr images. arXiv preprint arXiv:2402.18507 (2024).
32. Young, A.A., Li, B., Kirton, R.S., Cowan, B.R.: Generalized spatiotemporal myocardial strain analysis for dense and spamm imaging. Magnetic resonance in medicine 67(6), 1590-1599 (2012).
33. Zhang, M., Fletcher, P.T.: Bayesian principal geodesic analysis in diffeomorphic image registration. In: International Conference on Medical Image Computing and Computer-Assisted Intervention. pp. 121-128. Springer (2014). 34. Zhang, M., Fletcher, P.T.: Finite-dimensional lie algebras for fast diffeomorphic image registration. In: International Conference on Information Processing in Medical Imaging. pp. 249-260. Springer (2015).
35. Zhang, X., You, C., Ahn, S., Zhuang, J., Staib, L., Duncan, J.: Learning correspondences of cardiac motion from images using biomechanics-informed modeling. In: International Workshop on Statistical Atlases and Computational Models of the Heart. pp. 13-25. Springer (2022).

1. A computer implemented method of predicting motion data from cardiac magnetic resonance (CMR) cine data from videos having frames of image data, the method comprising:
using a computer having a processor and computer implemented memory storing software to implement machine learning models (MLM) stored in the memory;
using a registration mapping framework MLM to learn latent velocity features from intermediate deformations fields calculated with initial velocities of motion data taken from the frames of image data; and
using a probabilistic latent diffusion MLM to construct updated motion data from the latent velocity features by implementing steps comprising:
storing, in the memory of the computer, a noisy motion feature set corresponding to the frames of image data by iteratively adding random Gaussian noise to the latent velocity features in a forward diffusion process; and
applying a reverse diffusion process to the noisy motion feature set to create a refined set of latent velocity features;
applying the refined set of latent velocity features to a motion decoder to create the updated motion data.

2. The computer implemented method of claim 1 further comprising using the mapping framework MLM to determine respective intermediate deformation fields between an initial frame and each subsequent frame of the cine data.

3. The computer implemented method of claim 2, further comprising:
determining the respective intermediate deformation fields by storing a 3D volume of stacked image pairs with each pair comprising an initial frame of the image data and a respectively subsequent frame of the image data; and
applying the 3D volume to a U-Net MLM architecture.

4. The computer implemented method of claim 3, further comprising using the U-Net MLM architecture to calculate the respective intermediate deformation fields and determine latent velocity features of the frames of image data.

5. The computer implemented method of claim 4, wherein the latent velocity features comprise a time dependent velocity vector field calculated from the respective intermediate deformation fields based on initial velocity fields.

6. The computer implemented method of claim 2, further comprising using the mapping framework MLM and the intermediate deformation fields to learn other latent motion features besides latent velocity features in the cine data based on initial velocity fields.

7. The computer implemented method of claim 1, further comprising calculating and storing corrected deformation fields by implementing the probabilistic latent diffusion MLM in supervised learning using ground truth motion provided by previously confirmed displacement encoding with stimulated echoes (DENSE) data from historical training images.

8. The computer implemented method of claim 1, wherein the reverse diffusion process utilizes a deep neural network to calculate the refined set of latent velocity features for the frames of image data.

9. The computer implemented method of claim 8 wherein the reverse diffusion process

9. The computer implemented method of claim 1, wherein the motion decoder further comprises projecting the refined set of latent velocity features back into initial velocity fields based on the latent velocity features identified by the registration mapping framework MLM.

10. A non-transitory computer program product storing software for predicting motion data from cardiac magnetic resonance (CMR) cine data from videos having frames of image data, wherein the software provides a computer implemented method comprising:
using a computer having a processor and computer implemented memory storing the software to implement machine learning models (MLM) stored in the memory;
using a registration mapping framework MLM to learn latent velocity features from intermediate deformations fields calculated with initial velocities of motion data taken from the frames of image data; and
using a probabilistic latent diffusion MLM to construct updated motion data from the latent velocity features by implementing steps comprising:
storing, in the memory of the computer, a noisy motion feature set corresponding to the frames of image data by iteratively adding random Gaussian noise to the latent velocity features in a forward diffusion process; and
applying a reverse diffusion process to the noisy motion feature set to create a refined set of latent velocity features;
applying the refined set of latent velocity features to a motion decoder to create the updated motion data.
